(19) United States
(12) Patent Application Publication
(10) Pub. No.: US 2008/0265591 A1
(43) Pub. Date: Oct. 30, 2008

(54) SUPERPLASTIC ALUMINUM VEHICLE BUMPER

(75) Inventor: Nirnal M. Tolani, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/741,978

(22) Filed: Apr. 30, 2007

(51) Int. Cl. B60R 19/03; B21D 22/00; B60R 19/04; C22C 21/00

(52) U.S. Cl. 293/120; 293/102; 420/528; 72/352; 72/379.2

(57) ABSTRACT

A bumper for a vehicle for operation on the ground is provided having being formed of superplastic aluminum. The method for making and assembling bumpers made of superplastic aluminum is also set forth. Instructions regarding the tooling needed to manufacture the bumper, as well as the metallurgy and processes, are provided. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND

Modern medium and heavy duty vehicle manufacturers are increasingly turning to more aerodynamic overall designs in order to meet operator fuel mileage requirements. Additionally, modern medium and heavy duty vehicles are now characterized by sharp and pronounced styling features. Among other vehicle body panels and components that have been affected by these developments, the vehicle front bumper has been greatly revised to comport with the shape and styling of the vehicle as a whole. Because of these changes, conventional stamping processes are no longer effective to meet the cost and design requirements.

Solutions that have been utilized previously have included multi-piece stamped bumpers of both aluminum and steel, single-piece and multi-piece injection molded and reinforced plastic bumpers, bumpers made of single-piece and multi-piece reinforced fiberglass or sheet molding compound, and combinations thereof. Each of these types of bumpers or bumper assemblies has suffered from one or more drawbacks. Multi-piece aluminum and steel bumper sections produced by traditional matched-die stamping methods require expensive tooling. In the same way, injection molded plastic bumpers and bumper sections or components also require expensive tooling. Multi-piece aluminum and steel bumpers and bumper sections manufactured by traditional matched-die stamping are limited in the type and location of styling features, front surface openings, and overall depth of draw. Multi-piece steel bumpers have the added limitation of weight. Bumpers made of injection molded plastic, fiberglass, or sheet molding compound plastic are limited in strength, especially in cold temperatures. These plastic materials also do not accept a full range of automotive finishes.

### SUMMARY

It is advantageous in the design and construction of vehicle bumpers to provide a vehicle bumper that is lightweight, strong, corrosion resistant, aerodynamic, and visually appealing. It is further advantageous that the number of pieces that make up the vehicle bumper be minimized, and that the tooling that is necessary to manufacture the bumper be inexpensive. Often, these vehicle bumpers are complex in shape as a result of these requirements.

Superplastic aluminum alloy is a light weight, strong, and corrosion resistant material that may be heated, clamped, and blow-molded in a single-sided die in order to form complex and aerodynamic shapes. The fact that the forming die is single-sided means that the tooling cost is relatively low and tooling lead times relatively short. Recent improvements to tools and processes for forming superplastic aluminum have resulted in a capability to produce the “Class A” surface finish that would be required for vehicle bumpers, as well as parts that experience minimal springback, and accept a wide variety of finishes such as paint, chrome plating, and anodizing. Furthermore, the emergent use of superplastic aluminum alloy forming dies made of tool steel, instead of cast iron, some having integrated heating elements, has allowed the use of aluminum alloys such as 5083 aluminum alloy for superplastic forming, which is a somewhat lower cost Aluminum Magnesium Manganese (Al—Mg—Mn) aluminum alloy with only moderate superplastic properties, in thicknesses in up to about six millimeters.

Because of the complexity of shapes that may be produced by the superplastic aluminum alloy forming process, a minimal number of individual pieces are required, resulting in highly integrated, net-shape components that often consolidate many parts. This reduces the number of parts, fasteners, and labor-intensive assembly operations required. These facts taken together make a vehicle bumper formed of superplastic aluminum alloy an appealing, low cost alternative to conventionally-stamped steel or aluminum multi-piece bumpers, or bumpers formed of injection molded plastic, molded fiberglass, or sheet molding compound. Additionally, bumpers formed of superplastic aluminum alloy offer a 30% to 40% reduction in weight over steel or fiberglass, may be formed into complex shapes, exhibit excellent corrosion resistance especially when anodized, and are easily recyclable. Furthermore, bumpers formed of superplastic aluminum alloy may be welded or cold formed in additional operations.

As mentioned previously, the superplastic aluminum alloy forming process utilizes a single sided forming die. The superplastic aluminum alloy forming process is carried out between approximately 400 and approximately 550 degrees Celsius, while at the same time the die itself may be maintained at about 500 degrees Celsius. The superplastic aluminum alloy sheet blank is clamped at the edges of the forming die by a pressurizing ceiling plate, and pressurized gas is applied to the side of the superplastic aluminum alloy sheet blank opposite the forming die. The pressurized gas stretches the superplastic aluminum alloy sheet blank at rates of elongation in excess of those that may be obtained by conventional two-sided die stamping processes, until the superplastic aluminum alloy sheet blank takes the form of the single-sided die. That is to say, whereas usual alloys of aluminum formed in a conventional two-sided stamping die may be drawn to rates of elongation of approximately fifteen to twenty percent in a multiple stamping, even thirty percent for softer alloys, rates of elongation in the range of three hundred to five hundred percent are possible using superplastic aluminum alloy forming, with rates of elongation of around one thousand percent having been achieved. The final part trimming and piercing of holes may be performed by conventional trim and pierce dies, or by means of waterjet, laser, or plasma cutting operation.

### BRIEF DESCRIPTION OF THE DRAWINGS

FIG. 1—Vehicle with bumper.

FIG. 2—Prior art single-piece non-aerodynamic stamped bumper.

FIG. 3—Prior art multi-piece stamped bumper.

FIG. 4—Single-piece superplastic aluminum alloy bumper, untrimmed.

FIG. 5—Single-piece superplastic aluminum alloy bumper, trimmed.

FIG. 6A—Multi-piece superplastic aluminum alloy bumper, untrimmed, right hand.

FIG. 6B—Multi-piece superplastic aluminum alloy bumper, untrimmed, left hand.

FIG. 7—Left hand and right hand multi-piece superplastic aluminum alloy bumper, trimmed, in process of being assembled.

FIG. 8—Single-sided die for forming left hand multi-piece bumper from superplastic aluminum alloy.

FIG. 9—Superplastic aluminum alloy bumper forming die with ceiling plate.

FIG. 10—Superplastic aluminum alloy bumper forming die in process of forming superplastic aluminum alloy bumper.

### DETAILED DESCRIPTION OF THE INVENTION

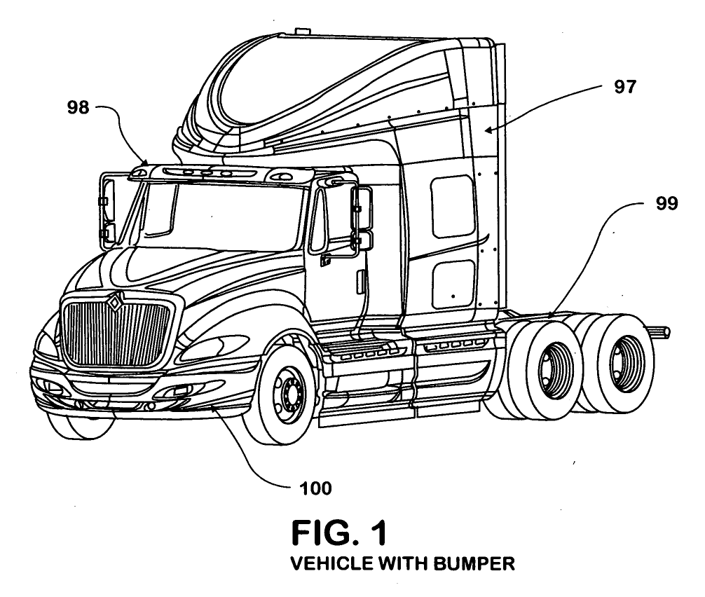

FIG. 1 shows a vehicle 97 having a body 98 and a chassis 99, and being further provided with a complex shaped aerodynamic bumper 100.

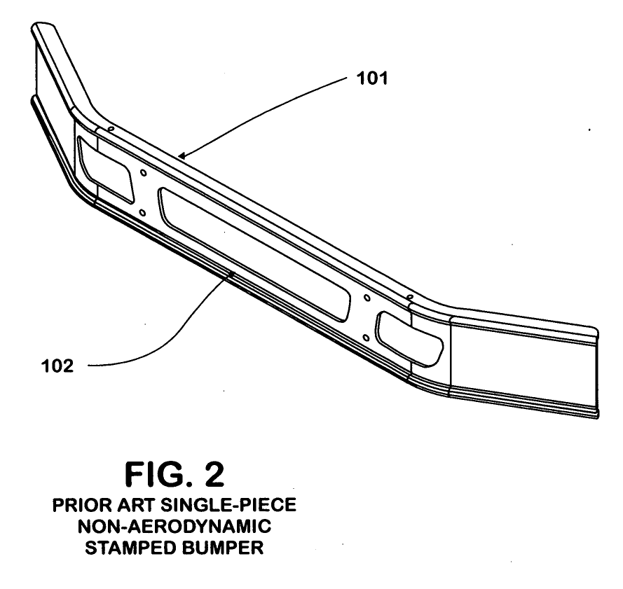

FIG. 2 shows a prior art single-piece non-aerodynamic stamped bumper 101. Front surface openings 102 may be provided for styling or air-flow purposes, or may be provided to accommodate vehicle lighting.

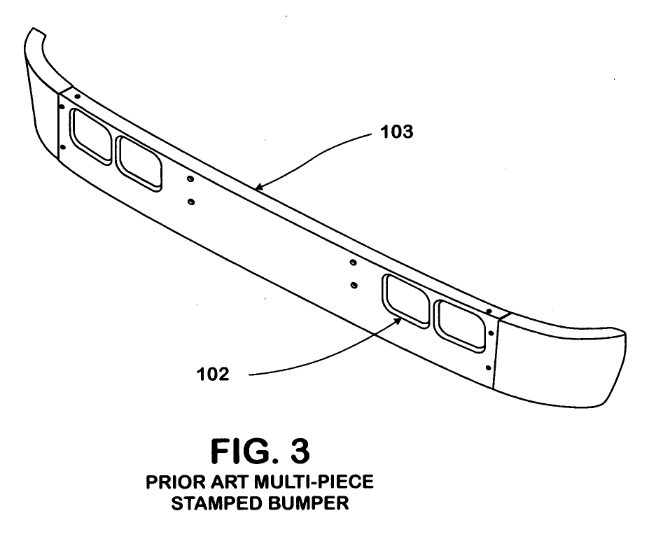

FIG. 3 shows a prior art multi-piece stamped bumper 103. Front surface openings 102 may again be provided for styling or air-flow purposes, or may be provided to accommodate vehicle lighting.

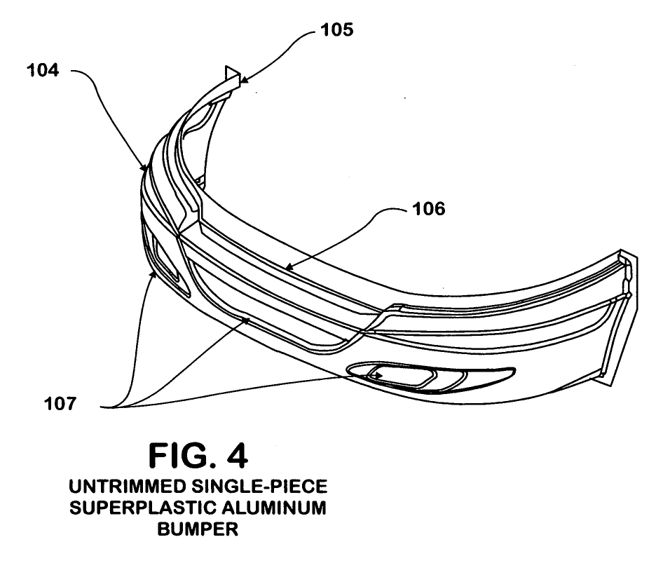

FIG. 4 shows a single-piece superplastic aluminum bumper 104 in an untrimmed state. A clamping flange 105 is present, as well as offal portions 106. Relief outlines 107 of front surface openings 102 are present, although the material of the front surface openings 102 has not yet been removed.

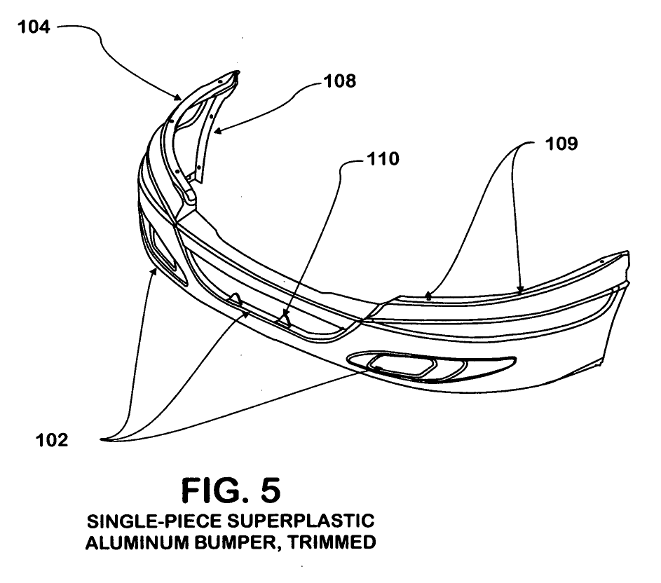

FIG. 5 shows a single-piece superplastic aluminum bumper 104 in a trimmed state. The offal portions 106 (not shown) have been removed in secondary operation. In the same way, the front surface openings 102 have been pierced and any inward flanges 108 that may be present have been formed in secondary operations. Additional holes 109 and miscellaneous formed features 110 may also be present.

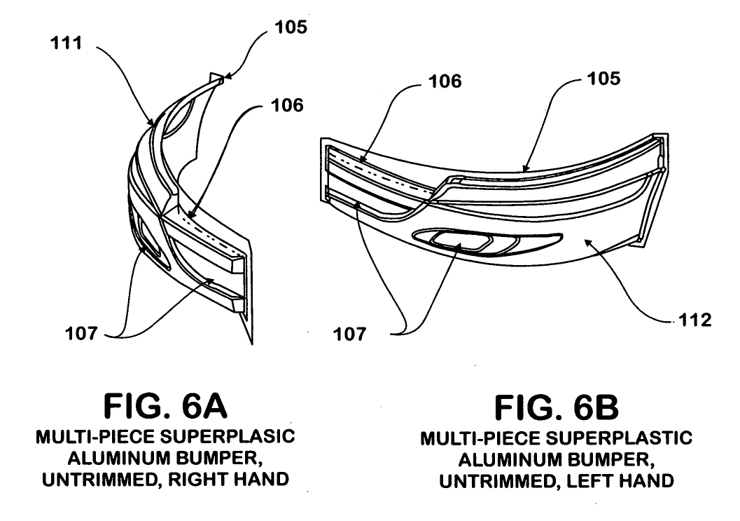

FIG. 6A shows a right hand multi-piece superplastic aluminum bumper 111 in an untrimmed state. A clamping flange 105 is again present, as well as offal portions 106. Relief outlines 107 of front surface openings 102 are also present, although the material of the front surface openings 102 has not yet been removed.

FIG. 6B shows a left hand multi-piece superplastic aluminum bumper 112 in an untrimmed state. A clamping flange 105, offal portions 106, and relief outlines 107 of front surface openings 102 are also present.

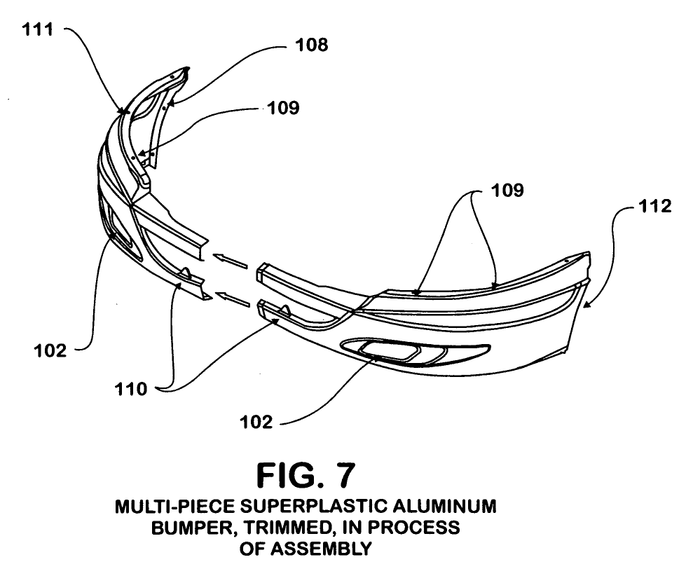

FIG. 7 shows right hand multi-piece superplastic aluminum bumper 111 and left hand multi-piece superplastic aluminum bumper 112, both in a trimmed state and in the process of being assembled one to the other. The offal portions 106 (not shown) have been removed in secondary operations. In the same way, the front surface openings 102 have been pierced and any inward flanges 108 that may be present have been formed in secondary operations. Additional holes 109 and miscellaneous formed features 110 may also be present.

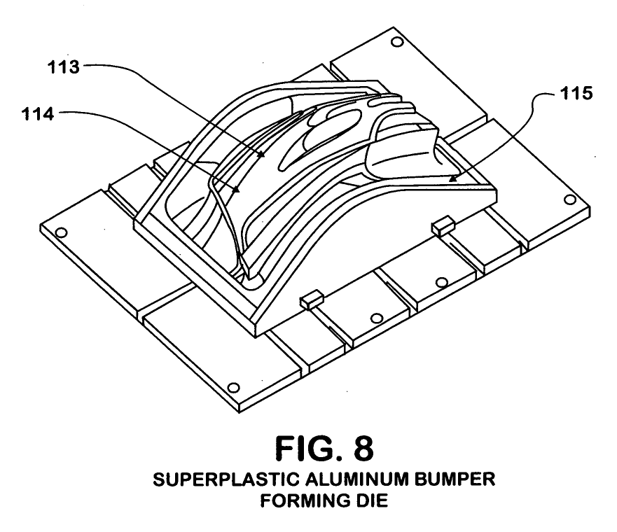

FIG. 8 shows a single-sided superplastic aluminum bumper forming die 113 for forming a left hand multi-piece superplastic aluminum bumper 112 (not shown). The single-sided superplastic aluminum bumper forming die 113, which may be made of tool steel, possesses a forming surface 114 in the impressed shape of the left hand multi-piece superplastic aluminum bumper 112 (not shown). Other embodiments of the single-sided superplastic aluminum bumper forming die 113 may possess a forming surface 114 in the impressed shape of the right hand multi-piece superplastic aluminum bumper 111 (not shown), or in the impressed shape of the single-piece superplastic aluminum bumper 104 (not shown). The single-sided superplastic aluminum bumper forming die 113 is also provided with a flat perimeter clamping surface 115, the function of which is shown in the next illustration. Note that the flat perimeter clamping surface 115 need not be entirely planar.

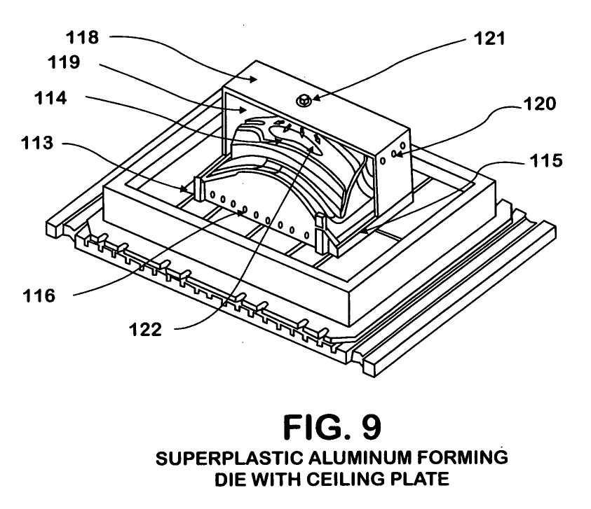

FIG. 9 shows a cutaway view of a single-sided superplastic aluminum bumper forming die 113 having a forming surface 114 and a flat perimeter clamping surface 115, similar to the single-sided superplastic aluminum bumper forming die 113 shown in FIG. 8. The single-sided superplastic aluminum bumper forming die 113 shown in FIG. 9 may again be made of tool steel and may be further provided with integral die heating elements 116, which integral die heating elements 116 may raise the temperature of the single-sided superplastic aluminum bumper forming die 113 to approximately 500 degrees Celsius. A ceiling plate 118 is shown placed over the top of the single-sided superplastic aluminum bumper forming die 113, which ceiling plate 118 is provided with a blowing chamber 119 and may be provided with integral ceiling plate heating elements 120, which integral ceiling plate heating elements 120 may raise the temperature of the ceiling plate 118 to approximately 500 degrees Celsius. A pressurized gas source 121 in the ceiling plate 118 supplies pressurized gas 122, which pressurized gas 122 may itself be heated, to the blowing chamber 119.

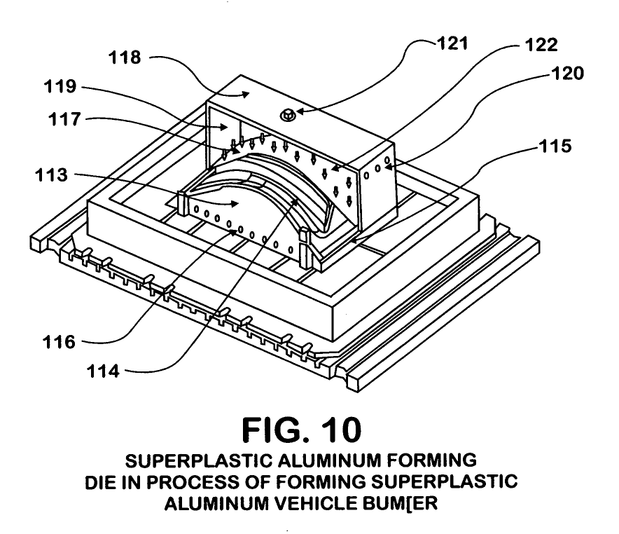

FIG. 10 shows a cutaway view of a single-sided superplastic aluminum bumper forming die 113 having a forming surface 114, a flat perimeter clamping surface 115, and integral die heating elements 116, similar to the single-sided superplastic aluminum bumper forming die 113 shown in FIG. 9. The single-sided superplastic aluminum bumper forming die 113 shown in FIG. 10 may again be made of tool steel, and may again be raised to a temperature of approximately 500 degrees Celsius by the integral die heating elements 116. A superplastic aluminum bumper blank 117 is clamped between a ceiling plate 118 and the flat perimeter clamping surface 115. The superplastic aluminum bumper blank 117 may have a temperature of approximately 400 degrees Celsius to approximately 550 degrees Celsius. The ceiling plate 118 is again provided with integral ceiling plate heating elements 120, a blowing chamber 119, and a pressurized gas source 121. The integral ceiling plate heating elements 120 may again raise the temperature of the ceiling plate 118 to approximately 500 degrees Celsius. The pressurized gas source 121 provides pressurized gas 122, which may be heated. The pressurized gas 122 will cause the superplastic aluminum bumper blank 117 to conform to the forming surface 114 of the single-sided superplastic aluminum bumper forming die 113, and will ultimately cause the superplastic aluminum bumper blank 117 to take the form of a single-piece superplastic aluminum bumper 104 (not shown) or a right hand or left hand multi-piece superplastic aluminum bumper, 111 or 112 respectively (not shown). The clamp load between the ceiling plate 118 and the flat perimeter clamping surface 115 of the single-sided superplastic aluminum bumper forming die 113 prevents the superplastic aluminum bumper blank 117 from pulling away from the superplastic aluminum bumper forming die 113 at its edges.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to a vehicle equipped with a superplastically formed aluminum bumper may also be inherent in the invention, without having been described above.

I claim:

1. A vehicle for operation on the ground, said vehicle having a body and a chassis, comprising:
a bumper attached to said chassis, said bumper being formed from superplastic aluminum alloy.

2. The vehicle for operation on the ground of claim 1, wherein:
said superplastic aluminum alloy further comprises 5083 superplastic aluminum alloy.

3. The vehicle for operation on the ground of claim 1, wherein:
said bumper further comprises a single piece bumper.

4. The vehicle for operation on the ground of claim 1, wherein:
said bumper further comprises a multi-piece bumper.

5. The vehicle for operation on the ground of claim 1, wherein:
said bumper further comprises a bumper that is complex in shape.

6. The vehicle for operation on the ground of claim 1, wherein:
said bumper further being formed from superplastic aluminum alloy deformed to at least one local rate of elongation of at least fifty percent during manufacture of said bumper.

7. The vehicle for operation on the ground of claim 6, wherein:
said bumper further being formed from superplastic aluminum alloy deformed to at least one local rate of elongation of at least one hundred percent during manufacture of said bumper.

8. The vehicle for operation on the ground of claim 1, wherein:
said bumper has a nominal thickness of at least approximately two and a half millimeters.

9. A vehicle bumper, comprising:
formed superplastic aluminum alloy.

10. The bumper of claim 9, wherein:
said superplastic aluminum alloy further comprises 5083 superplastic aluminum alloy.

11. The bumper of claim 9, wherein:
said bumper further comprises a single piece bumper.

12. The bumper of claim 9, wherein:
said bumper further comprises a multi-piece bumper.

13. The bumper of claim 9, wherein:
said bumper further comprises a bumper that is complex in shape.

14. The bumper of claim 9, wherein:
said superplastic aluminum alloy being deformed to at least one local rate of elongation of at least fifty percent during manufacture of said bumper.

15. The bumper of claim 14, wherein:
said superplastic aluminum alloy being deformed to at least one local rate of elongation of at least one hundred percent during manufacture of said bumper.

16. The bumper of claim 9, wherein:
said formed superplastic aluminum alloy has a nominal thickness of at least approximately two and a half millimeters.

17. A bumper for a vehicle manufactured by a process comprising:
providing a single-sided superplastic aluminum alloy bumper forming die, said single-sided superplastic aluminum alloy bumper forming die having a cavity in the impressed shape of a vehicle bumper and having a flat perimeter clamping surface;
placing a superplastic aluminum alloy sheet blank upon said flat perimeter clamping surface, said superplastic aluminum alloy sheet blank being heated to a temperature of between approximately 400 degrees Celsius and approximately 550 degrees Celsius;
placing a ceiling plate upon said superplastic aluminum alloy sheet blank, said ceiling plate being provided with a pressurized gas source, said ceiling plate clamping said superplastic aluminum alloy sheet blank to said superplastic aluminum alloy bumper forming die; and
blowing said superplastic aluminum alloy sheet blank into said cavity in said superplastic aluminum alloy bumper forming die using pressurized gas from said pressurized gas source.

18. The bumper of claim 17, wherein:
said superplastic aluminum sheet blank further comprises a 5083 superplastic aluminum alloy sheet blank.

19. The bumper of claim 17, wherein:
said single-sided superplastic aluminum alloy bumper forming die being made from tool steel.

20. The bumper of claim 17, wherein:
said single-sided superplastic aluminum alloy bumper forming die being further provided with integrated heating elements, said integrated heating elements functioning to raise the temperature of said single-sided superplastic aluminum alloy bumper forming die to at least approximately 500 degrees Celsius.
